(19) United States
(12) Patent Application Publication
(10) Pub. No.: US 2026/0071971 A1
(43) Pub. Date: Mar. 12, 2026

(54) WAFER INSPECTION DEVICE AND METHOD

(71) Applicant: NEXTIN, Inc., Hwaseong-si (KR)

(72) Inventors: Tae Hoon PARK, Yongin-si (KR); Ohhyung KWON, Hwaseong-si (KR); woojun HAN, Seoul (KR)

(21) Appl. No.: 19/324,367

(22) Filed: Sep. 10, 2025

(30) Foreign Application Priority Data
Sep. 10, 2024 (KR) 10-2024-0123135

(51) Int. Cl. G01N 21/95; G01N 21/47

(52) U.S. Cl. CPC G01N 21/9501; G01N 21/4738; G01N 2201/0634; G01N 2201/0636

(57) ABSTRACT

A wafer inspection device includes a light source, an illumination optical system disposed on a propagation path of light emitted from the light source, an objective lens for focusing light passing through the illumination optical system onto an inspection region, a light-receiving optical system for receiving reflected light and scattered light from the inspection region by using the objective lens, and a detection unit for detecting a reflected light signal and a scattered light signal. The light-receiving optical system includes an aperture stop for transmitting reflected light and scattered light passing through the objective lens, and a signal separator disposed at the rear of the aperture stop that guides reflected light along a first path, and that guides scattered light along a second path different from the first path.

### CROSS-REFERENCE TO RELATED APPLICATIONS

This application claims priority under 35 U.S.C. § 119 to Korean Patent Application No. 10-2024-0123135, filed on Sep. 10, 2024, in the Korean Intellectual Property Office, the disclosure of which is incorporated herein by reference in its entirety.

### TECHNICAL FIELD

The following disclosure relates to a wafer inspection device and a wafer inspection method, and more particularly, to a wafer inspection device for separately collecting a reflected light signal and a scattered light signal without blocking reflected light and scattered light emitted from an inspection region, and determining whether a defect occurs in a wafer by separately detecting an image obtained therefrom, and a wafer inspection method.

### BACKGROUND

In general, a semiconductor is manufactured by engraving a microcircuit pattern on a wafer and repeatedly performing a unit processes such as film formation, etching, and metal wiring.

As the semiconductor is more highly integrated and its process accelerates, defect inspection is becoming increasingly rigorous during the manufacturing process. The reason is that a partial defect occurring in the micropattern may directly result in semiconductor failure. Furthermore, with the emergence of a three-dimensional wafer structure designed to increase integration, there is an increasing need for technology to detect a defect inside the wafer.

There are several types of wafer inspection equipment, including electronic inspection equipment, optical inspection equipment, and thermal inspection equipment.

In particular, the optical inspection equipment is in high demand due to its advantages of non-contact operation, non-destructive sample handling, and fast detection speed. However, the optical inspection equipment has a detection limit due to the diffraction limit of light and is sensitive to the medium, shape, and position of a sample. Accordingly, ensuring detection sensitivity requires a high signal-to-noise ratio of a measured image.

In the signal-to-noise ratio (SNR), a signal is a light signal caused by the defect, and a noisy portion may be a background wafer circuit pattern. In this case, a filtering method that maximizes the defect signal relative to a background signal may be used as a method to minimize the background signal (i.e., the wafer circuit pattern) and maximize the defect signal.

A filter may be disposed in an illumination aperture or an imaging aperture, and by adjusting its shape and size, the filter may receive only the defect signal, which corresponds to a selective signal, while minimizing the background signal. The minimized background signal may be significantly reduced relative to the defect signal to ensure a high signal-to-noise ratio, thereby enabling reliable inspection.

The defect signal, which corresponds to the selective signal, necessarily causes scattering, and is thus disposed in a high-order optical order. On the other hand, a pattern signal, which corresponds to the background signal, primarily includes reflected light relatively and is disposed in a low-order optical order. Therefore, blocking the low-order optical order may reduce the background signal. However, the blocked light may result in a blurred background image, making it difficult to discern a wafer pattern shape. This issue makes it difficult to identify the position of the sample to be measured.

FIG. 1 is a diagram illustrating a light source 5 incident on an inspection region. An inspection region 1 may be a predetermined region on a wafer surface that is to be inspected, and correspond to an illumination region where the light source 5 is irradiated and illuminated. A microcircuit pattern 2 may be engraved on the wafer surface.

A defect 3 may occur in a process of engraving the microcircuit pattern 2 on a wafer and repeatedly performing unit processes such as film formation, etching, and metal wiring. The defect 3 may directly result in semiconductor failure, thus requiring a task to detect the defect.

To detect the defect 3 occurring on the wafer, the inspection region 1 may be illuminated. Illuminating the inspection region 1 may generate reflected light disposed at a low angle in a low order and scattered light disposed at a high angle in a high order. FIG. 1 illustrates light corresponding to the low order by a straight arrow and light corresponding to the high order by a dotted arrow.

A signal included in scattered light may have non-uniform frequency intensity, and a defect of interest (DOI) may include specific frequency information. In general, the DOI may include a large amount of high-order frequency information, and valid DOI information may thus be distributed on a periphery of a light receiving unit relative to the center of the light receiving unit.

That is, most of the light incident on the pattern 2 in the inspection region 1 may be reflected. Therefore, obtaining an image of reflected light may enable relatively accurate identification of information on the pattern 2. Most of the light incident on the defect 3 may be scattered. Therefore, obtaining an image of scattered light may enable relatively accurate identification of information on the defect 3.

Conventionally, to isolate only a high-order signal including abundant valid information, a blocking film having an inverted shape relative to an emission surface of the light source may be inserted into the light receiving unit. In this case, reflected light may be blocked, thus allowing a detection unit to fully receive a scattered light signal. However, the light receiving unit is incapable of receiving a signal from the blocked region, and the signal still includes weak but valid information, resulting in loss of the valid information.

### RELATED ART DOCUMENT

### Patent Document

U.S. Patent Application Publication No. 2007-0052953 (Mar. 8, 2007)

### SUMMARY

An embodiment of the present disclosure is directed to providing a wafer inspection device capable of simultaneously capturing images obtained from reflected light and scattered light to increase the contrast between the respective images, thereby enhancing sensitivity in defect detection.

In addition, the wafer inspection device may collect reflected and scattered light from an inspection region onto separate image sensors without blocking light to increase the contrast between the respective images, thereby ensuring sensitivity in defect detection.

In addition, the wafer inspection device may focus reflected light and scattered light onto separate focal points, thereby minimizing optical components and improving space efficiency.

In addition, the wafer inspection device may efficiently achieve an optimal inspection condition without replacing the components.

In addition, the wafer inspection device may simultaneously check a wafer pattern shape and a defect shape, thereby accurately identifying the presence or absence of a defect and a defect location.

Technical aspects of the present disclosure are not limited to those mentioned above, and other aspects not mentioned here may be clearly understood by those skilled in the art from the following description.

In one general aspect, a wafer inspection device includes: a light source; an illumination optical system disposed on a propagation path of light emitted from the light source; an objective lens for focusing light passing through the illumination optical system onto an inspection region; a light-receiving optical system for receiving reflected light and scattered light from the inspection region through the objective lens; and a detection unit for detecting a reflected light signal and a scattered light signal, respectively, wherein the light-receiving optical system includes an aperture stop for transmitting reflected light and scattered light passing through the objective lens, and a signal separator disposed at the rear of the aperture stop, guiding reflected light along a first path, and guiding scattered light along a second path different from the first path.

The detection unit may include a first image sensor disposed on the first path and detecting the reflected light signal, and a second image sensor disposed on the second path and detecting the scattered light signal.

The aperture stop may transmit reflected light through a partial region of the aperture, and transmit scattered light through an entire region of the aperture.

The signal separator may include a diffractive optical element, and the diffractive optical element includes a body and a plurality of diffraction gratings disposed on a partial region of the body, thereby transmitting reflected light through the region where the diffraction grating is disposed to be diffracted at a predetermined angle, and transmitting scattered light through a region where no diffraction grating is disposed to be transmitted in a straight line.

The light-receiving optical system may further include an imaging lens disposed on each of the first path and the second path, and if f_{img} represents a focal length of the imaging lens, the diffractive optical element is spaced apart from one side of the imaging lens by a distance equal to the length f_{img}, and each of the first image sensor and the second image sensor is spaced apart from the other side of the imaging lens by the distance equal to the length f_{img}.

If reflected light passes through the region where the diffraction grating is disposed and has a diffracted angle of θ, θ may satisfy the following Equation:

$${f}_{img} tan θ \geq d 1 + \frac{d 2}{2} \qquad [ Equation ]$$

(where f_{img} represents the focal length of the imaging lens, d₁ represents a width of each of the first image sensor and the second image sensor, and d₂ represents a distance between the first image sensor and the second image sensor).

The signal separator may include a digital mirror device (DMD), and the digital mirror device may include millions of micro-mirrors each having an angle individually adjusted.

The device may further include a controller for individually controlling the micro-mirrors, wherein the controller individually controls the micro-mirrors to adjust reflection directions of reflected light and scattered light.

The light-receiving optical system may further include a first imaging lens disposed on the first path and forming a focal point of reflected light guided along the first path onto the first image sensor, and a second imaging lens disposed on the second path and forming a focal point of scattered light guided along the second path onto the second image sensor.

The light-receiving optical system may further include a relay optical element for relaying a Fourier plane of the objective lens from a first spatial domain to a second spatial domain, the aperture stop being disposed in the first spatial domain, and the signal separator being disposed in the second spatial domain.

The relay optical element may correspond to a 4-f system (where, “f” represents a focal length).

The illumination optical system may include a field stop for adjusting a viewing angle of the light source, and a beam splitter for partially transmitting light passing through the field stop to the objective lens.

In another general aspect, a wafer inspection method includes: an illumination step of illuminating an inspection region by using a light source; a light receiving step of receiving reflected light and scattered light from an inspection region; and a detecting step of detecting a reflected light signal and a scattered light signal, respectively, wherein the light receiving step includes a step of collecting, by an objective lens, reflected light and scattered light, and a step of guiding reflected light on a Fourier plane of the objective lens along a first path and guiding scattered light along a second path different from the first path.

The light receiving step may further include a step of relaying the Fourier plane of the objective lens from a first spatial domain to a second spatial domain.

Reflected light and scattered light may be guided along the first path and the second path, respectively, by a diffractive optical element, and the diffractive optical element may include a body and a plurality of diffraction gratings formed on a partial region of the body, thereby transmitting reflected light through a region where the diffraction grating is disposed to be diffracted at a predetermined angle, and transmitting scattered light through a region where no diffraction grating is disposed to be transmitted in a straight line.

Reflected light and scattered light may be guided along the first and second paths by the digital mirror device.

The method may further include a determining step of determining the presence or absence of a defect by comparing a first image obtained by detecting reflected light with a second image obtained by detecting scattered light.

Other features and aspects will be apparent from the following detailed description, the drawings, and the claims.

### BRIEF DESCRIPTION OF THE DRAWINGS

FIG. 1 is a diagram illustrating a light source incident on an inspection region.

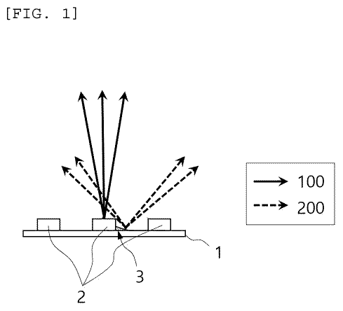

FIG. 2 illustrates an illumination optical system and an objective lens according to an embodiment of the present disclosure.

FIG. 3 is a schematic diagram of a light-receiving optical system according to a first embodiment of the present disclosure.

FIG. 4 is a diagram illustrating a diffractive optical element.

FIG. 5 is a schematic diagram of a light-receiving optical system according to a second embodiment of the present disclosure.

FIG. 6 is a diagram illustrating a digital mirror device (DMD).

FIG. 7 is a diagram illustrating an operation example of the digital mirror device.

FIG. 8 illustrates an example of a relay optical element according to the present disclosure.

FIGS. 9A and 9B illustrate images captured by first and second image sensors according to the present disclosure.

### DETAILED DESCRIPTION OF EMBODIMENTS

Hereinafter, embodiments of the present disclosure are described with reference to the accompanying drawings. However, these embodiments are provided only as examples, and the present disclosure is not limited to these specific embodiments described as examples.

A wafer inspection device according to the present disclosure refers to a device for inspecting a sample, and may correspond to surface inspection equipment for inspecting a surface of the sample such as a semiconductor wafer. The wafer inspection device according to an embodiment of the present disclosure may largely include a light source 5, an illumination optical system, an objective lens 20, a light-receiving optical system, and a detection unit 60.

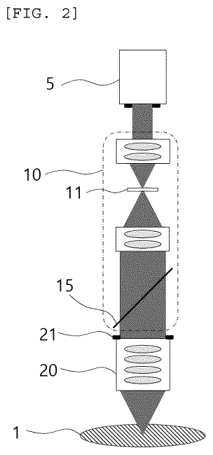

Hereinafter, the light source 5 and the illumination optical system are described with reference to FIG. 2. FIG. 2 schematically illustrates that light emitted from a light source of a wafer inspection device 1000 is focused on an inspection region according to an embodiment of the present disclosure.

The light source 5 refers to a means for generating and emitting light for illuminating the inspection region, and may include light-emitting diode (LED), laser, lamp, or the like. The light generated from the light source 5 may pass through the illumination optical system and the objective lens 20 to illuminate the inspection region 1.

The illumination optical system is for imaging an emission surface of the light source 5 onto an aperture stop of the objective lens, and may further include a plurality of lenses, a field stop 11, a beam splitter 15, or the like. A size of an illumination region on the wafer surface, where light is illuminated, may be adjusted by the field stop 11. The size of the illumination region may be appropriately adjusted by the field stop 11, thereby mitigating the occurrence of stray light, and improving measurement precision.

Light generated from the light source 5 may be partially reflected and partially pass through the beam splitter 15 to illuminate the wafer surface. A reflection-to-transmission ratio of the beam splitter may be within 5:5 to 7:3, and only about 50% to 30% of light emitted from the light source 5 may illuminate the wafer surface. Light passing through the beam splitter 15 may be focused through the objective lens 20 to illuminate the inspection region 1.

Light passing through the illumination optical system may be focused onto the inspection region 1 by the objective lens 20. Light incident on the inspection region 1 may be reflected or scattered, thus generating reflected light or scattered light. Reflected light and scattered light from the inspection region may then pass through the objective lens and be received by the light-receiving optical system.

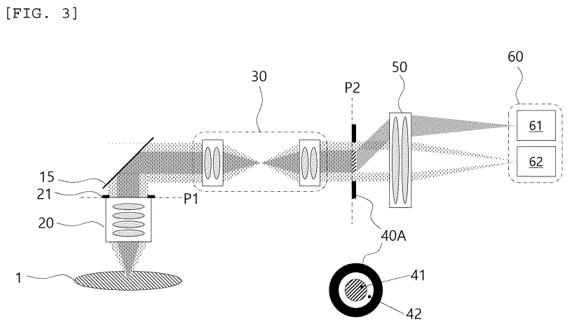

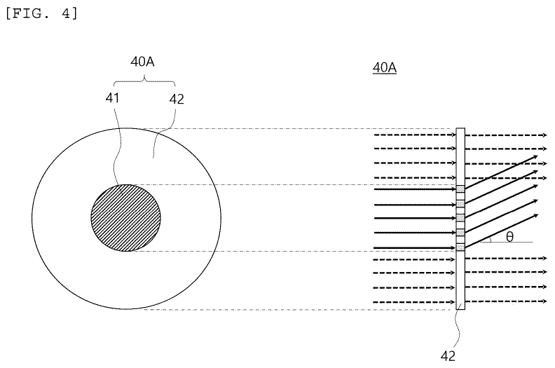

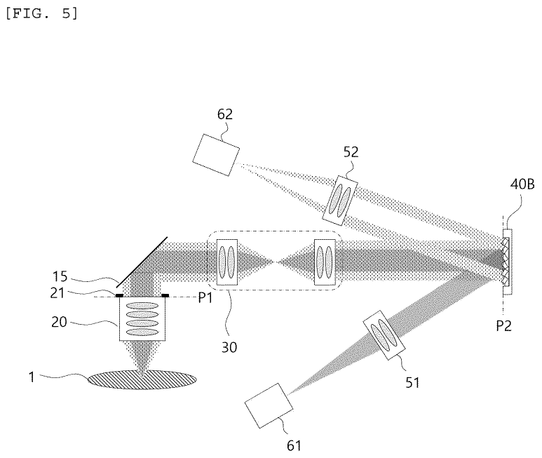

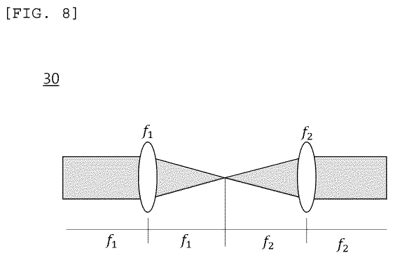

The light-receiving optical system and the detection unit according to the present disclosure are described in detail with reference to FIGS. 3 to 8. FIGS. 3 and 4 illustrate the light-receiving optical system according to a first embodiment of the present disclosure; FIGS. 5 to 7 illustrate the light-receiving optical system according to a second embodiment of the present disclosure; and FIG. 8 illustratively illustrates a relay optical element included in the light-receiving optical system.

The light-receiving optical system refers to an optical system for receiving reflected light and scattered light passing through the objective lens 20; may include an aperture stop 21 for transmitting reflected light and scattered light passing through the objective lens 20, and a signal separator 40 disposed at the rear of the aperture stop 21, guiding reflected light along a first path, and guiding scattered light along a second path different from the first path; and may further include the relay optical element capable of relaying a Fourier plane of the objective lens 20.

The aperture stop 21 refers to a flat plate having an aperture formed on the same center line as the objective lens 20, and may transmit both reflected light and scattered light through the aperture. The aperture stop 21 may collect even higher-order scattered light depending on an aperture size. Therefore, a factor related to the aperture size of the aperture stop 21 may be appropriately determined, thereby determining a numerical aperture (NA) of the objective lens 20.

The aperture stop 21 may transmit reflected light through a partial region of the aperture, and transmit scattered light through an entire region of the aperture. In detail, reflected light from the inspection region may form an image of the illumination emission surface again on the aperture by the objective lens 20. Therefore, reflected light may pass through the aperture while having a shape of the illumination emission surface. On the other hand, scattered light from the inspection region may be received at the maximum acceptance aperture by the objective lens 20, and distributed to pass through the entire aperture. Here, a signal including valid defect of interest (DOI) information is more likely to be present in an outer concentric region of the aperture stop rather than in a central concentric region of the aperture of the aperture stop. However, a signal including weak but still valid information may also be present in the central concentric region of the aperture.

That is, according to an embodiment of the present disclosure, the aperture stop 21 may receive signals transmitted through both central and outer regions of the aperture without blocking the signals, thereby minimizing wasted signals and efficiently collecting the valid DOI information, which may improve measurement accuracy.

Meanwhile, the inspection region and the aperture stop 21 may have a Fourier transform relationship. Therefore, reflected/diffracted/scattered light from the inspection region may form a Fourier spot at the aperture stop 21. Here, the strongest light may be 0th-order light, which is reflected light while having the same shape as the illumination emission surface, and scattered light may be distributed across the entire aperture stop 21. That is, a Fourier spot may be formed for 0th-order light while having the shape of the illumination emission surface, which corresponds to a specific region of the aperture stop 21, and a Fourier spot may be formed for scattered light distributed across the entire aperture stop 21.

As described above, the primary Fourier spot may be formed, and the secondary Fourier spot may be formed secondarily by the relay optical element described below. The signal separator 40 may be disposed in a relayed Fourier spot region, and an image formed in the relayed Fourier spot may be incident on the signal separator 40 to separate paths of reflected and scattered light.

The detection unit 60 may detect a reflected light signal and a scattered light signal, which have separate paths. The detection unit 60 may include a first image sensor 61 disposed on the first path and detecting the reflected light signal, and a second image sensor 62 disposed on the second path and detecting the scattered light signal. Each image sensor may correspond to, for example, a charge coupled device (CCD) sensor, a complementary metal oxide semiconductor (CMOS) sensor, an area sensor, a line sensor, or the like.

An image of the reflected light signal may be generated by the first image sensor 61, and an image of the scattered light signal may be generated by the second image sensor 62. Therefore, according to an embodiment of the present disclosure, the image of the reflected light signal, in which a shape of a pattern 2 is clearly revealed, and the image of the scattered light signal, in which a shape of a defect 3 is clearly revealed, may be simultaneously generated, respectively, thereby improving detection sensitivity of the defect 3 based on the contrast between the respective images.

In addition, a defect detection system without loss of valid information may be provided by collecting reflected light and scattered light from the inspection region 1 using the separate image sensors without blocking the signals, and increasing the contrast between the images generated by the respective sensors, thereby improving the sensitivity in defect detection.

Hereinafter, a first embodiment of a light-receiving optical system according to the present disclosure is described with reference to FIGS. 3 and 4. FIG. 3 is a schematic diagram of the light-receiving optical system according to the first embodiment of the present disclosure; and FIG. 4 is a diagram illustrating a diffractive optical element according to the first embodiment of the present disclosure.

In the first embodiment, the signal separator 40 may include a diffractive optical element 40A. Reflected light and scattered light passing through the aperture stop 21 may have their paths separated by the diffractive optical element 40A. In FIG. 3, the path through which reflected light passes is illustrated by a blue region, and the path through which scattered light passes is illustrated by a dot pattern region.

The diffractive optical element 40A may include a body 42 having the same optical axis as the aperture stop 21 and a plurality of diffraction gratings 41 disposed on a central region of the body 42. The body 42 may be made of a glass substrate, and if light is incident through a region other than the region where the diffraction grating 41 is disposed, light may thus be transmitted in a straight line without being diffracted.

In contrast, if light is incident through the region where the diffraction grating 41 is disposed, the diffraction grating may be designed to diffract light only in a specific direction. For example, the efficiency of 0th-order light may be designed to be 0%, and light incident perpendicular to the diffraction grating may thus be diffracted at a predetermined angle.

According to the present disclosure, the diffractive optical element 40A may transmit reflected light through the region where the diffraction grating is disposed to be diffracted at the predetermined angle, and transmit scattered light through the region where no diffraction grating is disposed to be transmitted in a straight line.

FIG. 4 illustratively illustrates the separation of the paths of reflected and scattered light passing through the diffractive optical element, and illustrates the reflected light path by a straight arrow and the scattered light path by a dotted arrow. Reflected light incident on the diffractive optical element 40A may be diffracted by a predetermined angle θ, while scattered light may be transmitted in a straight line without diffraction.

Referring back to FIG. 3, the light-receiving optical system according to the first embodiment of the present disclosure may further include an imaging lens 50 disposed on each of the first path and the second path. Light diffracted at the predetermined angle by the diffractive optical element 40A may be focused through the imaging lens having a wider field of view (FOV).

The imaging lens 50 may focus reflected light guided along the first path onto the first image sensor 61 and may focus scattered light guided along the second path onto the second image sensor 62. Therefore, according to an embodiment, reflected light and scattered light may be focused through one imaging lens 50, thereby minimizing optical components and improving space efficiency.

Meanwhile, if f_{img} represents a focal length of the imaging lens 50, the diffractive optical element may be spaced apart from one side of the imaging lens 50 by a distance equal to the length f_{img}, and the first image sensor 61 and the second image sensor 62 may be spaced apart from the other side of the imaging lens 50 by the distance equal to the length f_{img}, respectively. Therefore, a diffraction angle θ may be determined by the focal length f_{img} of the imaging lens 50.

In detail, if reflected light passes through the region where the diffraction grating 41 is disposed and θ represents the angle at which the diffraction grating 41 is diffracted, θ may satisfy the following Equation.

$${f}_{img} tan θ \geq d 1 + \frac{d 2}{2} \qquad [ Equation ]$$

(where f_{img} represents the focal length of the imaging lens, d₁ represents a width of each of the first image sensor and the second image sensor, and d₂ represents a distance between the first image sensor and the second image sensor).

If the diffraction angle θ satisfies the above Equation, the paths of reflected light and scattered light may be sufficiently separated, and each signal may be detected by the separate image sensors, thereby achieving a high signal-to-noise ratio. This configuration may enable the highest efficiency at infrared wavelengths of 800 to 1100 nm.

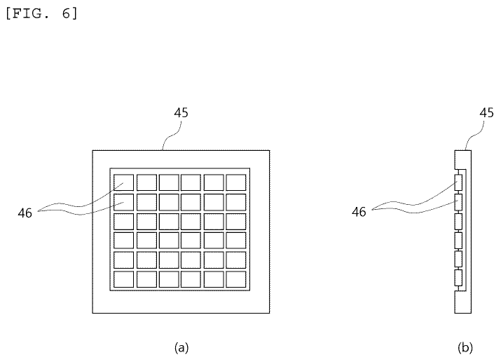

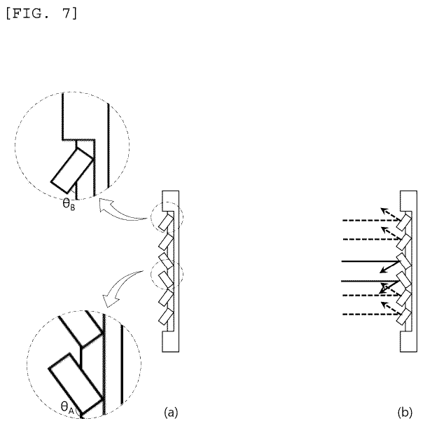

Hereinafter, the light-receiving optical system according to the second embodiment of the present disclosure is described with reference to FIGS. 5 to 7. FIG. 5 is a schematic diagram of the second embodiment of the light-receiving optical system; FIG. 6 is a front view and a side view illustrating a digital mirror device (DMD) according to the second embodiment; and FIG. 7 is a diagram illustrating an operation example of the digital mirror device according to the second embodiment.

In the second embodiment, the signal separator 40 may include a digital mirror device 40B. Reflected light and scattered light collected by the objective lens 20 may be reflected at different angles by the digital mirror device 40B, thereby separating the paths.

The digital mirror device 40B may include a main body 45 forming a body, and millions of micro-mirrors 46 disposed to reflect light from one surface of the main body 45. Each micro-mirror may represent at least one pixel in an image, and may be individually adjusted to adjust a reflection direction of light incident on each micro-mirror.

Meanwhile, the first image sensor 61 may be disposed on the first path for guiding reflected light, and the second image sensor 62 may be disposed on the second path for guiding scattered light.

Here, the light-receiving optical system may further include a first imaging lens 51 disposed on the first path and forming a focal point of reflected light guided along the first path onto an upper surface of the first image sensor, and a second imaging lens 52 disposed on the second path and forming a focal point of scattered light guided along the second path onto the second image sensor 62.

That is, the first path and the second path may have the separate imaging lenses 51 and 52, respectively.

Reflected light and scattered light are reflected at different angles, and it is thus preferable that the light-receiving optical system includes separate condensing lenses, unlike the first embodiment, in which the light-receiving optical system includes a common condensing lens in terms of light collection performance.

Meanwhile, according to the second embodiment, the light-receiving optical system may further include controller for individually controlling the micro-mirrors, and the controller may individually control the micro-mirrors to adjust reflection directions of reflected light and scattered light. In this case, the light-receiving optical system may further include a driving unit to adjust positions of the first and second image sensors 61 and 62, and the positions of the first and second image sensors may be adjusted based on reflection angles of reflected light and scattered light.

In detail, reflective surfaces of the micro-mirrors disposed in a region where reflected light is incident may form an angle θ_{A} with the main body to guide reflected light along the first path. In addition, the reflective surfaces of the micro-mirrors disposed in a region where scattered light is incident may form an angle θ_{B} with the main body to guide scattered light along the second path, which is different from the first path.

To clearly separate the paths of reflected light and scattered light, θ_{A} may be greater than 90° and less than 180°, θ_{B} may be greater than 0° and less than 90°, or the angular ranges of θ_{A} and θ_{B} may be opposite to each other. FIGS. 5 and 7 illustrate that θ_{A} is greater than 90° and less than 180°, and θ_{B} is greater than 0° and less than 90°.

If the angles of the micro-mirrors are configured as above, the first image sensor 61 and the second image sensor 62 may be disposed on both sides of the optical axis, which may be preferable in terms of space utilization.

If an optical filter is used to separate the light paths, it is difficult to change the path once the filter is installed, making it difficult to achieve an optimal inspection condition. On the other hand, according to the present disclosure, by using the digital mirror device capable of adjusting the reflection angle, the optimal inspection condition may be efficiently achieved without replacing the components. Furthermore, the light-receiving optical system may individually manipulate the micro-mirrors to set more filtering modes, thereby minimizing an amount of light lost due to scattering.

In the light-receiving optical system according to the first embodiment described above, reflected light or scattered light may be detected by each detector as only being transmitted or diffracted without reversing its propagation path. On the other hand, in the second embodiment, reflected light or scattered light may be detected by each detector after its propagation path is reversed by the digital mirror device. Therefore, the first embodiment described above may be applied to a case where an installation space of the wafer inspection device is relatively small, and the second embodiment may be applied to a case where a sufficient space for installing the optical equipment is available.

Meanwhile, the light-receiving optical system may further include a relay optical element 30 disposed between the objective lens 20 and the signal separator 40. The relay optical element corresponds to an optical element for adjusting a position at which the Fourier plane is formed. The relay optical element 30 may serve as a relay lens that enables parallel light to remain parallel.

In detail, the relay optical element 30 may relay the Fourier plane of the objective lens 20 from a first spatial domain P1 to a second spatial domain P2. That is, the relay optical element 30 may relay the Fourier plane formed in the first spatial domain P1 to the second spatial domain P2 disposed at the rear of the first spatial domain.

Here, the aperture stop 21 may be disposed in the first spatial domain P1, and the signal separator 40 may be disposed in the second spatial domain. The relay optical element 30 may include at least one field stop. The inspection region 1 and the aperture stop 21 may have the Fourier transform relationship, and the aperture stop 21 and the field stop of the relay optical element 30 may have an inverse Fourier transform relationship.

The field stop of the relay optical element 30 may have a conjugated relationship with the detection unit 60 and have a size matching that of the image sensor included in the detection unit to block ambient light.

The relay optical element may correspond to a 4f-system, for example, as illustrated in FIG. 8.

The 4-f system corresponds to an optical system in which a first lens having a focal length of f₁ and a second lens having a focal length of f₂ are arranged coaxially, and the first and second lenses are spaced apart from each other by a distance equal to the sum of f₁ and f₂. Light incident parallel to the optical axis of the first lens may be focused at a rear focal point of the first lens, then incident on the second lens, and pass through the second lens to be propagated to be parallel to the optical axis again. The magnification of the 4-f system may be adjusted by adjusting values of f₁ and f₂.

If the relay optical element corresponds to the 4-f system, the relay optical element may transmit complete frequency information without any loss of information. Therefore, according to an embodiment of the present disclosure, a wafer inspection device having improved defect detection accuracy may be provided.

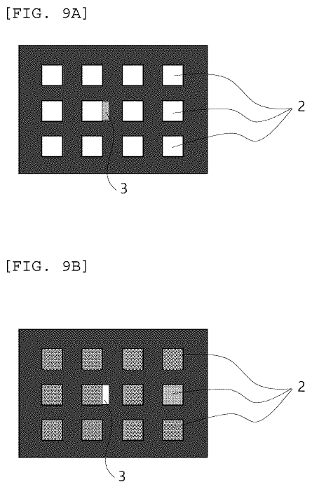

Hereinafter, the images obtained by the first image sensor and the second image sensor according to the present disclosure are described with reference to FIGS. 9A and 9B. FIG. 9A illustrates the first image of the same sample wafer that is generated by the first image sensor, and FIG. 9B illustrates the second image generated by the second image sensor.

The first image sensor 61 may correspond to a device capable of obtaining the first image by detecting the reflected light signal. Most of reflected light may originate from the pattern 2 on the wafer surface, and a region in the first image that appears bright may thus correspond to a region of the pattern 2.

Conversely, the second image sensor 62 may correspond to a device capable of obtaining the second image by detecting the scattered light signal. Most of scattered light may originate from the defect 3 on the wafer surface, and a region in the second image that appears bright may correspond to a region of the defect 3.

That is, as shown in FIGS. 9A and 9B, if the defect 3 occurs on the wafer, the defect 3 may appear darker than the pattern 2 of the wafer in the first image, and may appear brighter than the pattern 2 of the wafer in the second image.

Meanwhile, according to an embodiment of the present disclosure, the wafer inspection device may further include a determining unit for determining the presence or absence of the defect by comparing the first image with the second image. If the defect is determined to be present, the determining unit may further identify a defect location.

According to the present disclosure, the wafer inspection device may generate the first and second images by using inverted lighting to improve the contrast of scattering effects, thereby improving the sensitivity in defect detection.

In addition, the wafer inspection device may simultaneously visualize a wafer pattern shape and a defect shape, and compare the first image with the second image, thereby easily identifying the presence or absence of the defect and the defect location.

Hereinafter, a wafer inspection method according to the present disclosure is described. The wafer inspection method may include: an illumination step (S100) of illuminating an inspection region by using a light source; a light receiving step (S200) of receiving reflected light and scattered light in an inspection region; and a detecting step (S300) of detecting a reflected light signal and a scattered light signal, respectively. The light receiving step may include a step (S201) of collecting, by an objective lens, reflected light and scattered light, and a step (S202) of guiding reflected light on a Fourier plane of the objective lens along a first path and scattered light along a second path different from the first path.

The light receiving step (S200) may further include a step of relaying the Fourier plane of the objective lens from a first spatial domain P1 to a second spatial domain P2.

For example, in step S202, reflected light and scattered light may be guided along the first path and the second path, respectively, by a diffractive optical element. The diffractive optical element may include a body and a plurality of diffraction gratings disposed on a partial region of the body, thereby transmitting reflected light through a region where the diffraction grating is disposed to be diffracted at a predetermined angle, and transmitting scattered light through a region where no diffraction grating is disposed to be transmitted in a straight line.

As another example, in step S202, reflected light and scattered light may be guided along the first and second paths by the digital mirror device.

As described above, the reflected light signal and the scattered light signal may be respectively detected, and images thereof may be respectively obtained to minimize an amount of wasted light and simultaneously obtain inverted images, thereby increasing the detection sensitivity.

The wafer inspection device according to an embodiment of the present disclosure may achieve the improved detection sensitivity.

In addition, the wafer inspection device may achieve the improved space efficiency.

In addition, the wafer inspection device may efficiently achieve the optimal inspection condition without replacing the components, thereby reducing the inspection time.

In addition, the wafer inspection device may simultaneously check the wafer pattern shape and the defect shape, thereby improving the accuracy in identifying the presence or absence of a defect and a defect location.

Advantageous effects of the present disclosure are not limited to those mentioned above, and other effects not mentioned here may be clearly understood by those skilled in the art from the above description.

The embodiments of the present disclosure have been described hereinabove with reference to the accompanying drawings. However, it should be understood by those skilled in the art to which the present disclosure pertains that various modifications and alterations may be made without departing from the technical spirit or essential feature of the present disclosure. Therefore, it should be understood that the embodiments described hereinabove are illustrative rather than restrictive in all respects.

What is claimed is:

1. A wafer inspection device comprising:
a light source;
an illumination optical system disposed on a propagation path of light emitted from the light source;
an objective lens for focusing light passing through the illumination optical system onto an inspection region;
a light-receiving optical system for receiving reflected light and scattered light from the inspection region through the objective lens; and
a detection unit for detecting a reflected light signal and a scattered light signal, wherein the light-receiving optical system includes:
an aperture stop for transmitting reflected light and scattered light passing through the objective lens, and
a signal separator disposed at the rear of the aperture stop, the signal separator guiding reflected light along a first path and scattered light along a second path different from the first path.

2. The device of claim 1, wherein the detection unit comprises:
a first image sensor disposed on the first path and detecting the reflected light signal, and
a second image sensor disposed on the second path and detecting the scattered light signal.

3. The device of claim 2, wherein the aperture stop transmits reflected light through a partial region of the aperture, and transmits scattered light through an entire region of the aperture.

4. The device of claim 3, wherein:
the signal separator includes a diffractive optical element, and
the diffractive optical element includes a body and a plurality of diffraction gratings disposed on a partial region of the body, thereby transmitting reflected light through the region where the diffraction gratings are disposed to be diffracted at a predetermined angle, and transmitting scattered light through a region where no diffraction grating is disposed to be transmitted in a straight line.

5. The device of claim 4, wherein:
the light-receiving optical system further includes an imaging lens disposed on each of the first path and the second path,
f_{img} represents a focal length of the imaging lens,
the diffractive optical element is spaced apart from one side of the imaging lens by a distance equal to the length f_{img}, and
each of the first image sensor and the second image sensor is spaced apart from the other side of the imaging lens by the distance equal to the length f_{img}.

6. The device of claim 5, wherein:
the reflected light that passes through the region where the diffraction gratings are disposed and has a diffracted angle of θ, θ satisfies the following Equation:
$${f}_{img} tan θ \geq d 1 + \frac{d 2}{2} , \qquad [ Equation ]$$
d₁ represents a width of each of the first image sensor and the second image sensor, and
d₂ represents a distance between the first image sensor and the second image sensor.

7. The device of claim 3, wherein:
the signal separator includes a digital mirror device, and
the digital mirror device includes a plurality of micro-mirrors each having an individually adjusted angle.

8. The device of claim 7, further comprising a controller for individually controlling the plurality of micro-mirrors,
wherein the controller individually controls the plurality of micro-mirrors to adjust reflection directions of the reflected light and the scattered light.

9. The device of claim 7, wherein the light-receiving optical system further includes:
a first imaging lens disposed on the first path and forming a focal point of the reflected light guided along the first path onto the first image sensor, and
a second imaging lens disposed on the second path and forming a focal point of the scattered light guided along the second path onto the second image sensor.

10. The device of claim 1, wherein:
the light-receiving optical system further includes a relay optical element for relaying a Fourier plane of the objective lens from a first spatial domain to a second spatial domain,
the aperture stop is disposed in the first spatial domain, and
the signal separator is disposed in the second spatial domain.

11. The device of claim 10, wherein the relay optical element corresponds to a 4-f system.

12. The device of claim 1, wherein the illumination optical system includes:
a field stop for adjusting a viewing angle of the light source, and
a beam splitter for partially transmitting light passing through the field stop to the objective lens.

13. A method for wafer inspection, the method comprising:
illuminating an inspection region using a light source;
collecting, by an objective lens, reflected light and scattered light;
guiding reflected light on a Fourier plane of the objective lens along a first path and guiding scattered light along a second path different from the first path; and
detecting a reflected light signal and a scattered light signal.

14. The method of claim 13, further comprising relaying the Fourier plane of the objective lens from a first spatial domain to a second spatial domain.

15. The method of claim 13, wherein:
the reflected light and the scattered light are guided along the first path and the second path, respectively, by a diffractive optical element, and
the diffractive optical element includes a body and a plurality of diffraction gratings disposed on a partial region of the body, thereby transmitting the reflected light through a region where the diffraction gratings are disposed to be diffracted at a predetermined angle, and transmitting scattered light through a region where no diffraction grating is disposed to be transmitted in a straight line.

16. The method of claim 13, wherein the reflected light and the scattered light are guided along the first and second paths by a digital mirror device.

17. The method of claim 13, further comprising determining the presence or absence of a defect by comparing a first image obtained by detecting the reflected light with a second image obtained by detecting the scattered light.
